(19) United States
(12) Patent Application Publication
(10) Pub. No.: US 2006/0096966 A1
(43) Pub. Date: May 11, 2006

(54) Self-shielded flux cored electrode for fracture critical applications

(75) Inventors: Robert P. Munz, Jefferson, OH (US); Marie A. Quintana, Twinsburg, OH (US); Badri K. Narayanan, Euclid, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Lincoln Global, Inc., Cleveland, OH (US)

(21) Appl. No.: 10/983,439

(22) Filed: Nov. 8, 2004

(51) Int. Cl. B23K 35/02

(52) U.S. Cl. 219/145.22

(57) ABSTRACT

A self shielding cored electrode used to form weld beads having high Charpy V-Notch toughness. The cored electrode includes a metal sheath and fill composition. The fill composition includes a slag system having a gas generating compound, magnesium and at least three metals selected from the group consisting of aluminum, cerium, titanium and zirconium.

The invention relates generally to the field of welding and more particularly directed to electrodes useful for fracture critical applications.

### BACKGROUND OF THEE INVENTION

In the field of arc welding, the three (3) main types of arc welding are submerged arc welding (SAW), shielded metal arc welding (SMAW), and flux-cored arc welding (FCAW). In submerged arc welding, coalescence is produced by heating with an electric arc between a bare-metal electrode and the metal being worked. The welding is blanketed with a granular or fusible material or flux. The welding operation is started by striking an arc beneath the flux to produce heat to melt the surrounding flux so that it forms a subsurface conductive pool which is kept fluid by the continuous flow of current. The end of the electrode and the workpiece directly below it becomes molten, and molten filler metal is deposited from the electrode onto the work. The molten filler metal displaces the flux pool and forms the weld. In shielded metal arc welding, shielding is by a flux coating instead of a loose granular blanket of flux. In flux-cored electrodes, the flux is contained within the metal sheath.

In the art of welding, much prior effort has been expended in developing flux compositions of the type having predetermined flux components intended to perform in predetermined manners. A large number of compositions have been developed for use as fluxes in arc welding both for use generally as welding fluxes and for use as a coating on a metallic core or within a sheath. Fluxes are utilized in arc welding to control the arc stability, modify the weld metal composition, and provide protection from atmospheric contamination. Arc stability is commonly controlled by modifying the composition of the flux. It is therefore desirable to have substances which function well as plasma charge carriers in the flux mixture. Fluxes also modify the weld metal composition by rendering impurities in the metal more easily fusible and providing substances with which these impurities may combine, in preference to the metal to form slag. Other materials may be added to lower the slag melting point, to improve slag fluidity, and to serve as binders for the flux particles.

Coated electrodes and cored electrodes are commonly used in electric arc welding of steel base metals. These electrodes generally yield high strength welds in a single pass and multiple passes at high welding speeds. These electrodes are formulated to provide a solid, substantially nonporous weld bead with tensile strength, ductility and impact strength to meet the desired end use of various applications. The electrodes are also formulated to minimize the qualities of slag generated during a welding procedure. The slag after the welding procedure is removed to provide a clean surface that, if desired, can be later treated (e.g., painted, coated) to enhance appearance, inhibit corrosion, etc.

Cored electrodes are used increasingly as an alternative to solid weld wires for improved productivity in structural fabrication. Cored electrodes have a metal sheath and a core containing a composition of various materials. Cored electrodes typically provide increased weld deposition rates and produce wider and more consistent penetration profiles than many solid wires. Cored electrodes also typically generate less fumes and spatter, provide improved arc stability and produce weld deposits with improved wetting characteristics in comparison to many solid wires.

One type of welding operation that has presented many challenges is the welding of pipelines. High Charpy V-Notch toughness is highly desirable for weld beads used to connect pipelines. Unfortunately, the values of the Charpy V-Notch toughness is generally low in such applications. Self shielded flux cored (FCAW-S) electrodes used for fracture critical applications such as pipelines and off-shore construction applications have formed weld beads that have notoriously low values in Charpy V-Notch testing. These low values are believed to be in part caused by the presence of inclusions rich in oxides/nitrides of aluminum and magnesium. Aluminum and magnesium are commonly used as deoxidants in welding electrodes. Aluminum is also commonly used as a denitrider in electrodes. Commercial electrodes have been developed that use either titanium or zirconium as secondary denitriders; however, such electrodes still have not achieved the desired Charpy V-Notch toughness values.

In view of the present state of the art of welding electrodes, there is a need for a welding electrode that can be used to form high Charpy V-Notch toughness values for the weld bead, especially for fracture critical applications.

### SUMMARY OF THE INVENTION

The present invention pertains to welding electrodes, and more particularly, to a welding electrode that can be used to form a weld bead having high Charpy V-Notch toughness values.

The electrode of the present invention is particularly directed to cored electrodes having a metal sheath that surrounds the fill composition in the core of the sheath and will be described with particular reference thereto; however, it can be appreciated that other types of electrodes could be used. The cored electrode of the present invention has a fill composition which includes a slag system and metal alloy system that deposits a weld metal that forms a weld bead that is particularly useful in fracture critical applications such as, but not limited to, pipelines and/or off-shore construction applications.

In one aspect of the present invention, the electrode of the present invention can be a self shielding electrode. As such, little or no shielding gas is required when using the electrode. It can be appreciated that a shielding gas can be used. If such a shielding gas is used, the shielding gas is used in conjunction with the electrode to provide protection to the weld bead or buffer layers from elements and/or compounds in the atmosphere. The shielding gas generally includes one or more gasses. These one or more gasses are generally inert or substantially inert with respect to the composition of the weld bead or buffer layer. The shielding gas can include, but is not limited to CO₂ shielding gas or CO₂ and argon blend shielding gas wherein CO₂ constitutes about 2-40% of the blend. In one non-limiting embodiment of the invention, when a blended shielding gas is used, the shielding gas includes 5-25 percent by volume carbon dioxide and the balance of argon. As can be appreciated, other and/or additional inert or substantially inert gasses can be used.

In another and/or alternative aspect of the present invention, the cored electrode includes a metal sheath that is formed primarily from iron (e.g., carbon steel, low carbon steel, stainless steel, low alloy steel, etc.); however, the metal sheath can include other metals such as, but not limited to aluminum, antimony, bismuth, boron, carbon, cesium, chromium, cobalt, copper, lead, magnesium, manganese, molybdenum, nickel, niobium, silicon, sulfur, tin, titanium, tungsten, vanadium, zinc and/or zirconium. In one non-limiting embodiment of the invention, the metal sheath primarily includes iron and one or more other elements such as, but not limited to, carbon, chromium, copper, manganese, molybdenum, nickel and/or silicon. In another non-limiting embodiment of the invention, the iron content of the metal sheath is at least about 80 weight percent. In still another non-limiting embodiment of the invention, the sheath of the cored electrode includes low carbon steel. In yet another non-limiting embodiment of the invention, the sheath of the cored electrode includes a stainless steel sheath (e.g., 304, 304L, 314, etc.). When the fill composition is included in the cored electrode, the fill composition typically constitutes at least about 1 weight percent of the total electrode weight, and not more than about 55 weight percent of the total electrode weight, and typically about 10-50 weight percent of the total electrode weight, and more typically about 12-35 weight percent of the total electrode weight, and even more typically about 15-30 weight percent of the total electrode weight.

In still another and/or alternative aspect of the present invention, the cored electrode includes a metal sheath and fill composition that includes at least three metals that include Al, Ti, Zr and/or Ce in combination with Mg to achieve a weld bead having a high Charpy V-Notch toughness. It has been found that the use of this novel combination of metals in the electrode controls the nitride formation during welding so as to achieve the formation of a weld bead having high Charpy V-Notch toughness. This novel combination of metals in the electrode is believed to modify the sequence of nitride formation during arc welding. The combination of these metals inhibits the formation of nitrides that serve as nucleation sites for the formation of large oxide inclusions rich in aluminum and magnesium. These inclusions then act as stress raisers and crack initiators during impact toughness testing causing low toughness of the weld metal. The Charpy V-Notch toughness values of the weld bead can achieve average high values of at least about 80 ft-lbs @ −4° F. and about 45 ft-lbs @ −40° F., and typically about 90-140 ft-lbs @ −4° F. and about 70-110 ft-lbs @ −40° F., and more typically about 115-125 ft-lbs @ −4° F. and about 85-95 ft-lbs @ −40° F. The use of the novel combination of metals in the electrode results in less than 10 percent of the formed weld bead having Charpy V-Notch toughness values of less than about 35 ft-lbf @ −4° F. and less than about 20 ft-lbf @ −40° F. In one embodiment of the invention, the electrode includes magnesium and aluminum, titanium and zirconium. In another embodiment of the invention, the electrode includes magnesium, aluminum, titanium and cesium. In still another embodiment of the invention, the electrode includes magnesium aluminum, titanium, zirconium and cesium. In yet another embodiment of the invention, the electrode includes magnesium, aluminum, zirconium and cesium. In still yet another embodiment of the invention, the electrode includes magnesium, titanium, zirconium and cesium. The magnesium content of the fill composition is generally at least about 2 weight percent, typically about 2-25 weight percent, and more typically about 3-18-weight percent. The aluminum content of the fill composition, when used, is generally at least about 2 weight percent, typically about 2-25 weight percent, and more typically about 3-18 weight percent. The titanium content of the fill composition, when used, is generally less than about 12 weight percent, typically less than about 8 weight percent, and more typically about 0-5 weight percent. The zirconium content of the fill composition, when used, is generally less than about 12 weight percent, typically less than about 8 weight percent, and more typically about 0-5 weight percent. The cesium content of the fill composition, when used, is generally less than about 12 weight percent, typically less than about 8 weight percent, and more typically about 0-5 weight percent.

In yet another and/or alternative aspect of the present invention, the electrode of the present invention includes a fill composition that has a slag system which enhances the weld layer(s) or buffer layer(s) formed by the electrode. The one or more slag forming agents in the fill composition also at least partially shield the formed weld bead or deposited buffer layers from the atmosphere. The fill composition typically includes one or more metal alloying agents selected to at least closely match the desired weld metal composition and/or to obtain the desired properties of the formed weld bead. The components of the fill composition can include one or more metal oxides (e.g., aluminum oxide, boron oxide, calcium oxide, chromium oxide, iron oxide, lithium oxide, magnesium oxide, niobium oxide, potassium oxide, silicon dioxide, sodium oxide, tin oxide, titanium oxide, vanadium oxide, zirconium oxide, etc.), one or more metal fluorides (e.g., barium fluoride, bismuth fluoride, calcium fluoride, lithium fluoride, potassium fluoride, sodium fluoride, Teflon, etc.), and/or one or more metal agents (e.g., aluminum, antimony, bismuth, boron, calcium, carbon, cesium, chromium, cobalt, copper, iron, lead, magnesium, manganese, molybdenum, nickel, niobium, silicon, sulfur, tin, titanium, tungsten, vanadium, zinc, zirconium, etc.). The slag system of the fill composition is used to at least partially provide protection to the weld metal during and/or after a deposition procedure and/or to facilitate in a particular deposition procedure. In still another non-limiting embodiment of the invention, the slag system includes at least one deposition protection agent. In one non-limiting aspect of this embodiment, at least one of the deposition protection agents include a gas generating compound that generates a shielding gas during the metal deposition operation. The gas generating compound generally decomposes during the welding operation and releases a gas that at least partially protects the weld metal or buffer layers (e.g., CO₂ generating compounds, fluoride generating compounds, etc.). The released gas has the effect of reducing the partial pressure of nitrogen in the arc environment so that nitrogen pickup in the deposited metal is reduced. Excessive nitrogen on the deposited metal can lead to adverse porosity in the deposited metal which can compromise the physical properties and appearance of the deposited metal. The released gas also or alternatively can scrub moisture from the arc region thereby reducing the amount of hydrogen absorption by the deposited metal. By reducing the moisture about the deposited metal, a reduced amount of hydrogen from the water is absorbed into the deposited metal thereby reducing the porosity of the deposited metal. In one particular non-limiting aspect of this embodiment, the gas generating compound includes a fluoride generating compound (e.g., BaF₂, CaF₂, K₃AlF₆, LiF, etc.). In one non-limiting formulation, the one or more fluoride generating compounds constitute a majority of the gas generating compounds. In one particular non-limiting aspect of this embodiment, the gas generating compound constitutes at least about 0.1 weight percent of the electrode, typically about 0.2-25 weight percent of the electrode, more typically about 1-20 weight percent of the electrode, and even more typically about 3-18 weight percent of the electrode. The gas generating compound also or alternatively constitutes at least about 1 weight percent of the slag system, typically about 2-80 weight percent of the slag system, more typically about 15-70 weight percent of the slag system, and even more typically about 25-65 weight percent of the slag system. In yet another non-limiting embodiment of the invention, the slag system can include a) at least one bulk agent that is used to cover and protect the deposited metal layers from the atmosphere until the metal deposited layers have at least partially solidified, b) at least one slag wetting agent, c) arc stabilization agent, d) slag removal agent, and/or e) a surface deposition agent. The slag wetting agent, when used, facilitates in ensuring that the slag fully covers the deposited metal to protect the deposited metal from the atmosphere until the metal deposited layers has at least partially solidified and/or to facilitate in the appearance of the deposited metal. The stabilization agent, when used, facilitates in producing a quiet arc that minimizes spatter. The surface deposition agent, when used, contributes to the shine and overall surface appearance of the deposited metal. The slag removal agent, when used, contributes to the easy removal of the slag on and/or around the deposited metal. The slag system can also include agents that increase and/or decrease the viscosity of the slag, and/or reduce fume production.

It is an object of the invention to provide a metal deposition and process for forming such a metal deposition that has improved high Charpy V-Notch toughness values.

Another and/or alternative object of the present invention is the provision of a flux cored electrode that can form a metal deposition that having improved high Charpy V-Notch toughness values.

Still another and/or alternative object of the present invention is the provision of a flux cored electrode that is self shielding.

Yet another and/or alternative object of the present invention is the provision of a flux cored electrode that can form weld bead for fracture critical applications.

Still yet another and/or alternative object of the present invention is the provision of a flux cored electrode that controls the formation of nitrides during the welding process to reduce the formation of large oxide inclusions in the weld metal.

These and other objects and advantages will become apparent from the discussion of the distinction between the invention and the prior art, and when considering the preferred embodiment as shown in the accompanying drawings.

### BRIEF DESCRIPTION OF THE DRAWINGS

FIG. 1 is a graph illustrating the difference of the Charpy V-Notch values between the flux cored electrode of the present invention and a conventional flux cored electrode; and,

FIG. 2 is a graph illustrating the effect of three of the four elements in the flux cored electrode that are used to reduce the frequency of Charpy V-Notch values less than about 40 ft-lbs @ −4° F.

### DETAILED DESCRIPTION OF THE INVENTION

The present invention is directed to an improved self shielding flux cored electrode that is formulated to form a weld metal for use in fracture critical applications such as for connecting pipelines or for various types of off-shore construction applications. The formed weld bead can achieve high average Charpy V-Notch toughness of about 120 ft-lbs @ −4° F., 90 ft-lbs @ −40° F. and less than 10% of the formed weld beads having low Charpy V-Notch values of less than about 35 ft-lbs @ −4° F. and <20 ft-lbs @ −40° F. The flux cored electrode includes a novel slag system that enables the flux cored electrode to be used without a shielding gas.

The flux cored electrode typically has a low carbon mild steel sheath or a stainless steel sheath which constitutes about 70-90 weight percent of the electrode. The balance of the electrode weight constitutes the fill composition in the core of the electrode.

The fill composition includes a novel combination of metals that are used to inhibit the formation of nitrides in the weld bead, which nitrides serve as nucleation sites for the formation of large oxide inclusions rich in aluminum and magnesium. These inclusions act as stress raisers and crack initiators during impact toughness testing thereby resulting in low toughness of the weld metal. The novel metal combination includes magnesium in combination with three or more metals, namely Aluminum, Titanium, Zirconium and/or Cesium. Typically, the magnesium constitutes the first or second largest percentage of these metals. When aluminum is used in the fill composition, the aluminum constitutes the first or second largest percentage of these metals.

In one non-limiting example of the self shielding flux cored electrode of the present invention includes a carbon steel sheath that constitutes about 70-90 weight percent of the electrode, and fill composition that includes about 10-30 weight percent of the electrode, which fill composition includes by weight percent of the fill composition:

| | |
|---|---|
| Fluoride compound | 20-80% |
| Metal oxide | 3-50% |
| Mg | 1-25% |
| Ce, Al, Ti and/or Zr | 1-55% |
| Metal alloys | 0-30% |

In another non-limiting example of the self shielding flux cored electrode of the present invention includes a carbon steel sheath that constitutes about 72-88 weight percent of the electrode, and fill composition that includes about 12-28 weight percent of the electrode, which fill composition includes by weight percent of the fill composition:

| | |
|---|---|
| Fluoride compound | 20-60% |
| Metal oxide | 3-35% |
| Arc stabilizer | 2-35% |
| Mg | 1-25% |
| Al | 1-25% |
| Ce, Ti and/or Zr | 1-30% |
| Metal alloys | 0-30% |

In still another non-limiting example of the self shielding flux cored electrode of the present invention includes a carbon steel sheath that constitutes about 72-88 weight percent of the electrode, and fill composition that includes about 12-28 weight percent of the electrode, which fill composition includes by weight percent of the fill composition:

| | |
|---|---|
| BaF₂ | 30-50% |
| Fe₂O₃ | 10-25% |
| LiF | 5-12% |
| Li₂O | 0-10% |
| Mg | 5-15% |
| Al | 5-15% |
| Ce | 0-3% |
| Ti | 0-3% |
| Zr | 0-3% |
| Mn | 0-6% |
| Ni | 0-6% |

In the above examples, three or four of the metals Al, Ce, Ti and Zr are included in the fill composition.

In still another non-limiting example of the self shielding flux cored electrode of the present invention includes a carbon steel sheath that constitutes about 72-88 weight percent of the electrode, and fill composition that includes about 12-28 weight percent of the electrode, which fill composition includes by weight percent of the fill composition:

| | |
|---|---|
| BaF₂ | 35-42% |
| Fe₂O₃ | 16-22% |
| LiF | 6-10% |
| Li₂O | 0-7% |
| Mg | 7-12% |
| Al | 7-12% |
| Ce | 0-2% |
| Ti | 0.05-2% |
| Zr | 0.05-2.8% |
| Mn | 0-4% |
| Ni | 0-5% |

Several non-limiting examples of the relative compositions of aluminum, cesium, titanium and zirconium in the fill composition include about 4-10% Al, about 0.1-1% Ti and about 1-2.5% Zr; about 8-13.5% Al, about 0.4-1.8% Ti and about 0.1-1.8% Zr; about 4.5-9% Al, about 0.1-0.8% Ti and about 1.3-2.1% Zr; about 9-13% Al, about 0.7-1.2% Ti and about 0.1-1.4% Zr; about 3.9-8.8% Al, about 0.05-1.8% Ce, about 0.05-1% Ti and about 0.08-1.6% Zr; about 4.3-12 Al %, about 0.08-1.7% Ce and about 0.05-2% Ti; and about 4.4-12.4% Al, about 0.05-1.8% Ce and about 0.05-2.1% Zr. As can be appreciated, other weight percent combinations of these metals in the fill composition can be used.

The believed functions of the components of the fill composition, set forth above, are described generally below; however, one or more of the components can have other or additional functions. As such, it will be appreciated that the discussed functions are the believed functions, not the actual or complete functions of such components.

The barium fluoride and iron oxide provide bulk to the slag so that the slag can cover the deposited weld metal. The fluoride compounds provide the gas generating characteristics of the fill composition. The fluoride compounds (e.g., BaF₂, LiF) typically at least partially vaporize in the electric arc during welding thereby forming a gas barrier about the region of deposited metal from the electrode. This gas barrier reduces the partial pressure of the nitrogen in the environment about the molten deposited metal, thereby reducing the amount of nitrogen pickup by the deposited metal. The reduced amount of nitrogen in the deposited metal reduces the amount of porosity in the deposited metal, thereby enhancing the physical properties and appearance of the deposited metal. The gas barrier also facilitates in scrubbing the moisture from the arc region, thereby reducing the amount of hydrogen absorption by the deposited metal. Excessive amounts of hydrogen in the deposited metal can cause porosity problems in the deposited metal. Moisture about the arc region is a source of hydrogen. The reduced amount of nitrogen about the weld metal also reduces the nitride formation in the weld metal. The lithium compounds (LiF, LiO₂) provide arc stabilization during the depositing of metal on a workpiece. The arc stabilization agent facilitates in producing a soft quiet arc that generates little spatter during the deposition process. The lithium compound also can function as a slag wetting agent, and/or facilitate in promoting slag glassiness and slag removal when the slag and deposited weld metal have cooled. The magnesium metal, aluminum metal, cesium metal, titanium metal and zirconium metal are deoxidizers that inhibit oxide formation in the weld metal and/or nitride formation in the weld metal. One or more of these metals can also be alloying agents. The manganese and nickel are primarily alloying agents. The alloying agents in the fill composition will vary depending on the composition of the metal sheath.

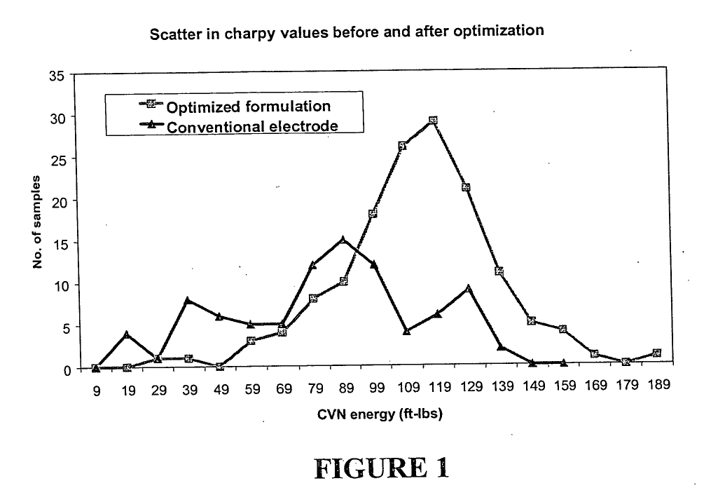

Reference is made to FIG. 1 which compares the average notch toughness of the weld metals formed by the cored electrode of the present invention to conventional prior art cored electrodes. The graph illustrates that the average Charpy V-Notch toughness of the weld bead formed by the cored electrode of the present invention has on average significantly greater values than weld beads formed by prior cored electrodes.

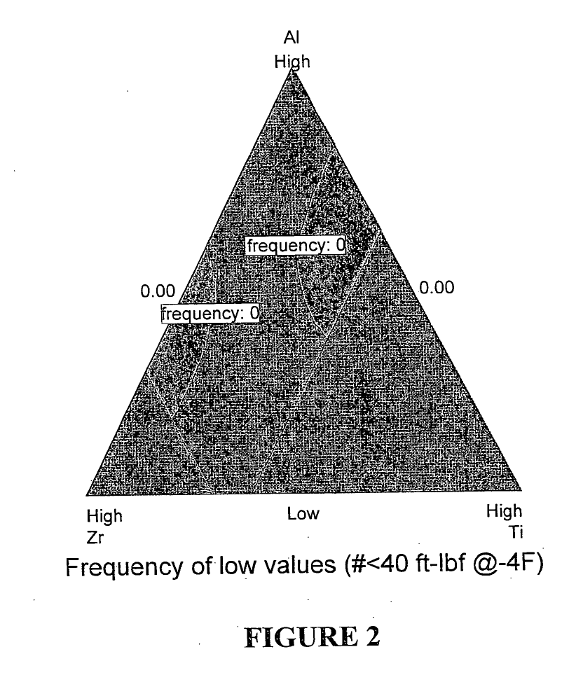

Reference is now made to FIG. 2 which is a graph illustrating the amount of nitride formation in the weld bead as a function of the amount of aluminum, titanium and zirconium contained in the fill composition. Certain regions of the graph illustrate that nearly no nitride formation occurs in the weld metal when certain amounts of aluminum titanium and zirconium in combination with magnesium on the fill composition of the cored electrode are used.

These and other modifications of the discussed embodiments, as well as other embodiments of the invention, will be obvious and suggested to those skilled in the art from the disclosure herein, whereby it is to be distinctly understood that the foregoing descriptive matter is to be interpreted merely as illustrative of the present invention and not as a limitation thereof.

1. A cored electrode to form a weld bead having high Charpy V-Notch toughness comprising a metal sheath and fill composition, said fill composition including a slag system that contains gas generating compounds, magnesium and at least three metals selected from the group consisting of aluminum, cerium, titanium and zirconium.

2. The cored electrode as defined in claim 1, wherein the content of said gas generating compound is sufficient to fully shield said metal deposition during a deposition process.

3. The cored electrode as defined in claim 1, wherein said metal sheath is carbon steel metal or a stainless steel.

4. The cored electrode as defined in claim 1, wherein said fill composition constitutes about 10-40 weight percent of the cored electrode.

5. The cored electrode as defined in claim 1, wherein said gas generating compound includes a fluoride generating compound, said gas generating compound constituting about 20-70 weight percent of said filling composition.

6. The cored electrode as defined in claim 5, wherein said fluoride generating compound constitutes a majority of said gas generating compound, said fluoride generating compound including calcium fluoride, barium fluoride, sodium fluoride, potassium fluoride, lithium fluoride or combinations thereof. fluoride or combinations thereof.

7. The cored electrode as defined in claim 6, wherein said fluoride generating compound includes a majority of barium fluoride.

8. The cored electrode as defined in claim 1, wherein said fill composition includes by weight percent:

| | |
|---|---|
| Fluoride compound | 20-80% |
| Metal oxide | 3-50% |
| Mg | 1-25% |
| Ce, Al, Ti and/or Zr | 1-55% |
| Metal alloys | 0-30% |

9. The cored electrode as defined in claim 1, wherein said fill composition includes by weight percent:

| | |
|---|---|
| Fluoride compound | 20-60% |
| Metal oxide | 3-35% |
| Arc stabilizer | 2-35% |
| Mg | 1-25% |
| Al | 1-25% |
| Ce, Ti and/or Zr | 1-30% |
| Metal alloys | 0-30% |

10. The cored electrode as defined in claim 1, wherein said fill composition includes by weight percent:

| | |
|---|---|
| BaF₂ | 30-50% |
| Fe₂O₃ | 10-25% |
| LiF | 5-12% |
| Li₂O | 0-10% |
| Mg | 5-15% |
| Al | 5-15% |
| Ce | 0-3% |
| Ti | 0-3% |
| Zr | 0-3% |
| Mn | 0-6% |
| Ni | 0-6% |

11. The cored electrode as defined in claim 1, wherein said fill composition includes by weight percent:

| | |
|---|---|
| BaF₂ | 35-42% |
| Fe₂O₃ | 16-22% |
| LiF | 6-10% |
| Li₂O | 0-7% |
| Mg | 7-12% |
| Al | 7-12% |
| Ce | 0-2% |
| Ti | 0.05-2% |
| Zr | 0.05-2.8% |
| Mn | 0-4% |
| Ni | 0-5% |

12. The cored electrode as defined in claim 1, wherein said fill composition includes by weight percent about 4-10% Al, about 0.1-1% Ti and about 1-2.5% Zr.

13. The cored electrode as defined in claim 1, wherein said fill composition includes by weight percent about 8-13.5% Al, about 0.4-1.8% Ti and about 0.1-1.8% Zr.

14. The cored electrode as defined in claim 1, wherein said fill composition includes by weight percent about 4.5-9% Al, about 0.1-0.8% Ti and about 1.3-2.1% Zr.

15. The cored electrode as defined in claim 1, wherein said fill composition includes by weight percent about 9-13% Al, about 0.7-1.2% Ti and about 0.1-1.4% Zr.

16. The cored electrode as defined in claim 1, wherein said fill composition includes by weight percent about 3.9-8.8% Al, about 0.05-1.8% Ce, about 0.05-1% Ti and about 0.08-1.6% Zr.

17. The cored electrode as defined in claim 1, wherein said fill composition includes by weight percent about 4.3-12% Al, about 0.08-1.7% Ce and about 0.05-2% Ti.

18. The cored electrode as defined in claim 1, wherein said fill composition includes by weight percent about 4.4-12.4% Al, about 0.05-1.8% Ce and about 0.05-2.1% Zr.

19. A method of forming a metal deposition having average high values of over about 90 ft-lbs @ −4° F. and over about 45 ft-lbs @ −40° F. comprising:
a) providing a cored electrode that includes a metal sheath and fill composition, said fill composition including a slag system that contains gas generating compound, magnesium and at least three metals selected from the group consisting of aluminum, cerium, titanium and zirconium; and,
b) at least partially melting said cored electrode by an electric current to cause said gas generating compound to release a shielding gas and cause a melted portion of said cored electrode to deposit molten metal on a workpiece, said molten metal including a low concentration of nitrides.

20. The method as defined in claim 19, wherein the content of said gas generating compound is sufficient to fully shield said metal deposition during a deposition process.

21. The method as defined in claim 19, wherein said metal sheath is carbon steel metal or a stainless steel.

22. The method as defined in claim 19, wherein said fill composition constitutes about 10-40 weight percent of the cored electrode.

23. The method as defined in claim 19, wherein said gas generating compound includes a fluoride generating compound, said gas generating compound constituting about 20-70 weight percent of said filling composition.

24. The method as defined in claim 23, wherein said fluoride generating compound constitutes a majority of said gas generating compound, said fluoride generating compound including calcium fluoride, barium fluoride, sodium fluoride, potassium fluoride, lithium fluoride or combinations thereof.

25. The method as defined in claim 24, wherein said fluoride generating compound includes a majority of barium fluoride.

26. The method as defined in claim 19, wherein said fill composition includes by weight percent:

| | |
|---|---|
| Fluoride compound | 20-80% |
| Metal oxide | 3-50% |
| Mg | 1-25% |
| Ce, Al, Ti and/or Zr | 1-55% |
| Metal alloys | 0-30% |

27. The method as defined in claim 19, wherein said fill composition includes by weight percent:

| | |
|---|---|
| Fluoride compound | 20-60% |
| Metal oxide | 3-35% |
| Arc stabilizer | 2-35% |
| Mg | 1-25% |
| Al | 1-25% |
| Ce, Ti and/or Zr | 1-30% |
| Metal alloys | 0-30% |

28. The method as defined in claim 19, wherein said fill composition includes by weight percent:

| | |
|---|---|
| BaF₂ | 30-50% |
| Fe₂O₃ | 10-25% |
| LiF | 5-12% |
| Li₂O | 0-10% |
| Mg | 5-15% |
| Al | 5-15% |
| Ce | 0-3% |
| Ti | 0-3% |
| Zr | 0-3% |
| Mn | 0-6% |
| Ni | 0-6% |

29. The method as defined in claim 19, wherein said fill composition includes by weight percent:

| | |
|---|---|
| BaF₂ | 35-42% |
| Fe₂O₃ | 16-22% |
| LiF | 6-10% |
| Li₂O | 0-7% |
| Mg | 7-12% |
| Al | 7-12% |
| Ce | 0-2% |
| Ti | 0.05-2% |
| Zr | 0.05-2.8% |
| Mn | 0-4% |
| Ni | 0-5% |

30. The method as defined in claim 19, wherein said fill composition includes by weight percent about 4-10% Al, about 0.1-1% Ti and about 1-2.5% Zr.

31. The method as defined in claim 19, wherein said fill composition includes by weight percent about 8-13.5% Al, about 0.4-1.8% Ti and about 0.1-1.8% Zr.

32. The method as defined in claim 19, wherein said fill composition includes by weight percent about 4.5-9% Al, about 0.1-0.8% Ti and about 1.3-2.1% Zr.

33. The method as defined in claim 19, wherein said fill composition includes by weight percent about 9-13% Al, about 0.7-1.2% Ti and about 0.1-1.4% Zr.

34. The method as defined in claim 19, wherein said fill composition includes by weight percent about 3.9-8.8% Al, about 0.05-1.8% Ce, about 0.05-1% Ti and about 0.08-1.6% Zr.

35. The method as defined in claim 19, wherein said fill composition includes by weight percent about 4.3-12% Al, about 0.08-1.7% Ce and about 0.05-2% Ti.

36. The method as defined in claim 19, wherein said fill composition includes by weight percent about 4.4-12.4% Al, about 0.05-1.8% Ce and about 0.05-2.1% Zr.
